(19) United States
(12) Patent Application Publication
(10) Pub. No.: US 2025/0327718 A1
(43) Pub. Date: Oct. 23, 2025

(54) MONITORING SYSTEM, MONITORING METHOD, AND ARITHMETIC DEVICE

(71) Applicant: NIPPON TELEGRAPH AND TELEPHONE CORPORATION, Tokyo (JP)

(72) Inventors: Daiki KOBAYASHI, Tokyo (JP); Toshiki NAKANISHI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/861,762

(22) PCT Filed: May 2, 2022
(86) PCT No.: PCT/JP2022/019534

§ 371 Date: Oct. 30, 2024

(51) Int. Cl. G01M 13/00

(52) U.S. Cl. CPC G01M 13/00

(57) ABSTRACT

A monitoring system (1) includes: a vibrator (10) that vibrates a tubular structure (40) in each axis direction of a first axis direction and a second axis direction orthogonal to the first axis; one or more triaxial accelerometers (20) that are provided on the tubular structure (40) and measure acceleration each time the tubular structure (40) is vibrated in each axis direction of the first axis direction and the second axis direction; and a computation device (30) that derives a vibration mode in each axis direction of the first axis direction and the second axis direction based on measurement values of the acceleration and determines whether a U-bolt (41) is detached or supporting hardware (42) is detached based on the vibration mode.

### TECHNICAL FIELD

The present disclosure relates to a monitoring system, a monitoring method, and a computation device that remotely monitor detachment of a U-bolt and supporting hardware for fixing a tubular structure.

### BACKGROUND ART

In the related art, a tubular structure is fixed to various places including a bridge beam of a bridge by a U-bolt and supporting hardware. However, in a case where the tubular structure vibrates, the U-bolt or the supporting hardware for fixing the tubular structure may loosen and become detached. For this reason, states of the U-bolt and the supporting hardware for fixing the tubular structure are constantly monitored, and in a case where detachment occurs, it is necessary to promptly perform repair.

Non Patent Literature 1 describes development and practical application of a bolt axial force measurement device using ultrasonic waves. According to Non Patent Literature 1, loosening of a hexagonal bolt can be detected using an ultrasonic probe. However, a method for detecting loosening of a U-bolt by using the ultrasonic probe has not been established. Further, there is a problem in terms of cost in attaching the bolt axial force measurement device to each U-bolt.

Non Patent Literature 2 describes a frequency detection experiment by hammering a suspended material of a bridge. However, since the tubular structure is installed in a place where erecting scaffolding is difficult, such as a bridge beam, human labor is required to perform striking by hammering. In addition, since the logic for evaluating goodness has not yet been established, there is a problem that reliability is low.

### CITATION LIST

### Non Patent Literature

Non Patent Literature 1: Takayuki Makino and two others, “Choonpa wo riyo shita boruto-jiku-ryoku sokutei sochi no kaihatsu to jitsuyo-ka (in Japanese) (Development and practical application of bolt axial force measurement device using ultrasonic waves)”, Journal of the Japan Society of Precision Engineering, precision machinery, February 1977, Vol. 43, No. 506, published on pages 223-232 Non Patent Literature 2: Tetsuya Ito and two others, “Kyoryo buzai kenzen-do hyoka wo mokuteki to shita hanmaringu ni yoru tsuri-zai kashin jikken (in Japanese) (Suspended material vibration experiment using hammering for the purpose of evaluating goodness of bridge members)”, The Research Presentation of The Japan Society of Civil Engineers-West (2009.3), published on pages 75-76

### SUMMARY OF INVENTION

### Technical Problem

In a case where the tubular structure is installed in a place where scaffold is bad, such as a bridge beam of a bridge, or in a dangerous place such as a place in a nuclear power plant, there is a problem that it takes a lot of human labor and time to constantly monitor the tubular structure.

The present invention has been made in view of such circumstances, and an object of the present invention is to provide a monitoring system, a monitoring method, and a computation device that remotely monitor detachment of a U-bolt and detachment of supporting hardware by receiving measurement values of triaxial accelerometers provided on a tubular structure in a wired manner or a wireless manner.

### Solution to Problem

In order to solve the above problem, according to the present embodiment, there is provided a monitoring system that remotely monitors detachment of a U-bolt and supporting hardware for fixing a tubular structure, the monitoring system including: a vibrator that vibrates the tubular structure in each axis direction of a first axis direction and a second axis direction orthogonal to the first axis; one or more triaxial accelerometers that are provided on the tubular structure and measure acceleration each time the tubular structure is vibrated in each axis direction of the first axis direction and the second axis direction; and a computation device that derives a vibration mode in each axis direction of the first axis direction and the second axis direction based on measurement values of the acceleration and determines whether the U-bolt is detached or the supporting hardware is detached based on the vibration mode.

In order to solve the above problem, according to the present embodiment, there is provided a monitoring method that remotely monitors detachment of a U-bolt and supporting hardware for fixing a tubular structure, the monitoring method including: a step of vibrating, via a vibrator, the tubular structure in each axis direction of a first axis direction and a second axis direction orthogonal to the first axis; a step of measuring, via one or more triaxial accelerometers, acceleration each time the tubular structure is vibrated in each axis direction of the first axis direction and the second axis direction; a step of deriving, via a computation device, a vibration mode in each axis direction of the first axis direction and the second axis direction based on measurement values; and a step of determining, via the computation device, whether the U-bolt is detached or the supporting hardware is detached based on the vibration mode.

In order to solve the above problem, according to the present embodiment, there is provided a computation device that determines detachment of a U-bolt and supporting hardware for fixing a tubular structure, the computation device including: a reception unit that receives measurement values of acceleration from one or more triaxial accelerometers each time the tubular structure is vibrated in each axis direction of a first axis direction and a second axis direction orthogonal to the first axis; a computation unit that derives a vibration mode based on the measurement values and determines whether the U-bolt is detached or the supporting hardware is detached based on the vibration mode; and a display unit that displays and visualizes the vibration mode.

### Advantageous Effects of Invention

According to the present disclosure, it is possible to constantly and remotely determine detachment of the U-bolt and the supporting hardware.

### BRIEF DESCRIPTION OF DRAWINGS

FIG. 1 is a block diagram illustrating a configuration example of a monitoring system according to an embodiment of the present disclosure.

FIG. 2 is a schematic view of a tubular structure in a good state.

FIG. 3 is a schematic view of a tubular structure in a state where a U-bolt is in a detached state.

FIG. 4 is a schematic view of a tubular structure in a state where a U-bolt and supporting hardware are in a detached state.

FIG. 5 is a block diagram illustrating a configuration example of a computation device according to the embodiment of the present disclosure.

FIG. 6 is a diagram illustrating a vibration mode of a tubular structure by ODS analysis in a state where a U-bolt and supporting hardware are in a good state.

FIG. 7 is a diagram illustrating a vibration mode of a tubular structure by ODS analysis in a state where a U-bolt is in a detached state.

FIG. 8 is a diagram illustrating a vibration mode of a tubular structure by ODS analysis in a state where a U-bolt and supporting hardware are in a detached state.

FIG. 9 is a graph of a frequency response function representing a specific vibration mode for detecting that a U-bolt is in a detached state.

FIG. 10 is a graph of a frequency response function representing a specific vibration mode for detecting that supporting hardware is in a detached state.

FIG. 11 is a flowchart illustrating an example of a monitoring method executed by the monitoring system according to the embodiment of the present disclosure.

FIG. 12 is a block diagram illustrating a schematic configuration of a computer that functions as the computation device.

### DESCRIPTION OF EMBODIMENTS

Hereinafter, modes for carrying out the present invention will be described in detail with reference to the drawings. The present invention is not limited to an embodiment to be described below, and various modifications can be made within the scope of the gist of the present invention.

### Monitoring System

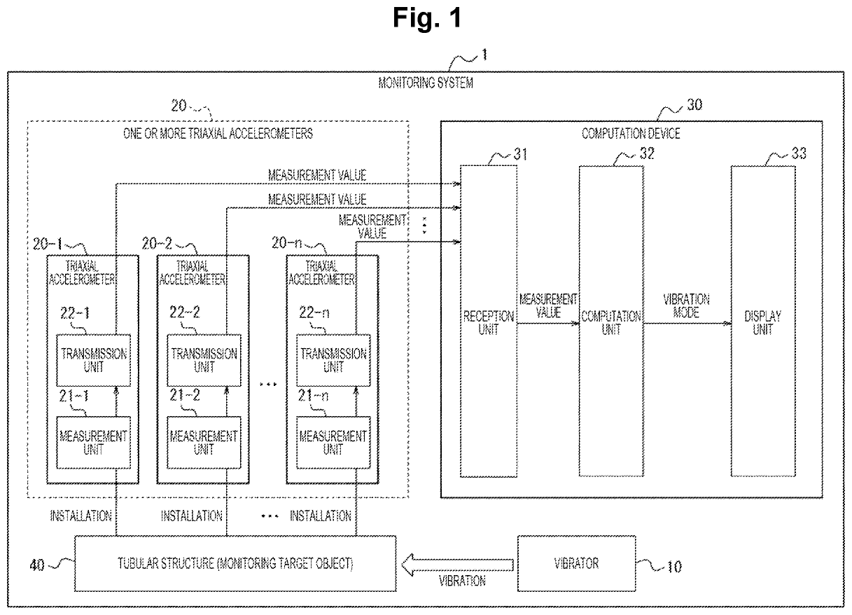

FIG. 1 is a block diagram illustrating a configuration example of a monitoring system 1 according to an embodiment of the present disclosure. As illustrated in FIG. 1, the monitoring system 1 includes a vibrator 10, one or more triaxial accelerometers 20, and a computation device 30. The monitoring system 1 remotely monitors detachment of a U-bolt 41 and supporting hardware 42 that fix a tubular structure 40.

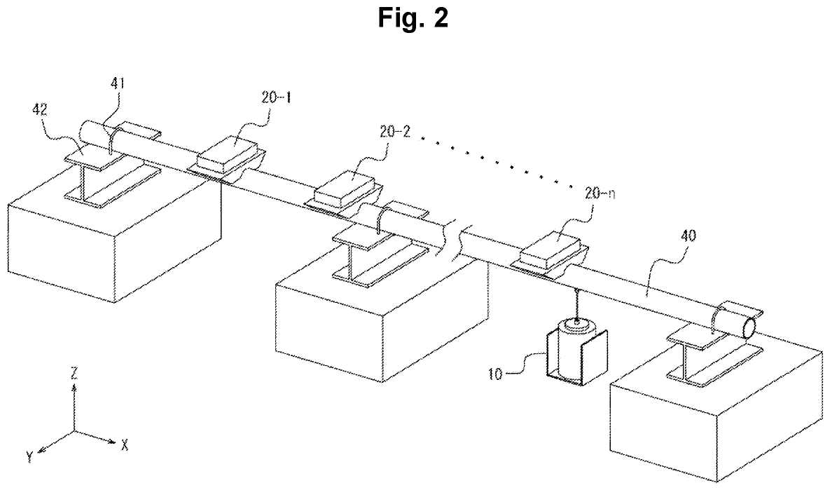

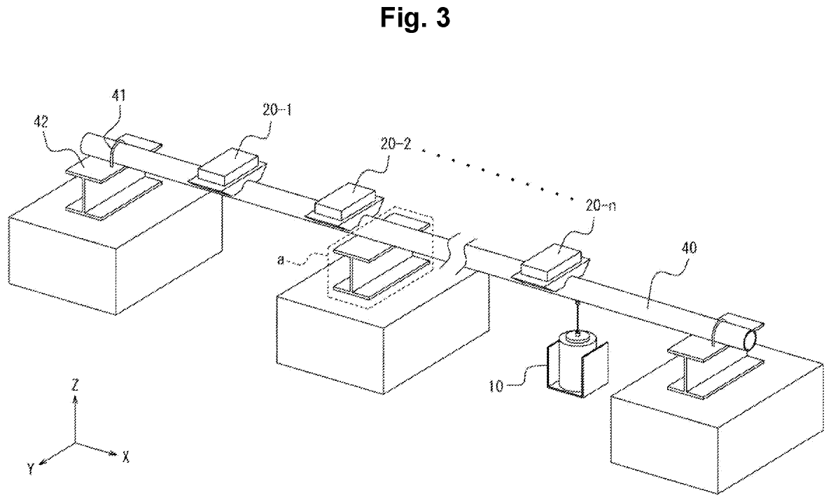

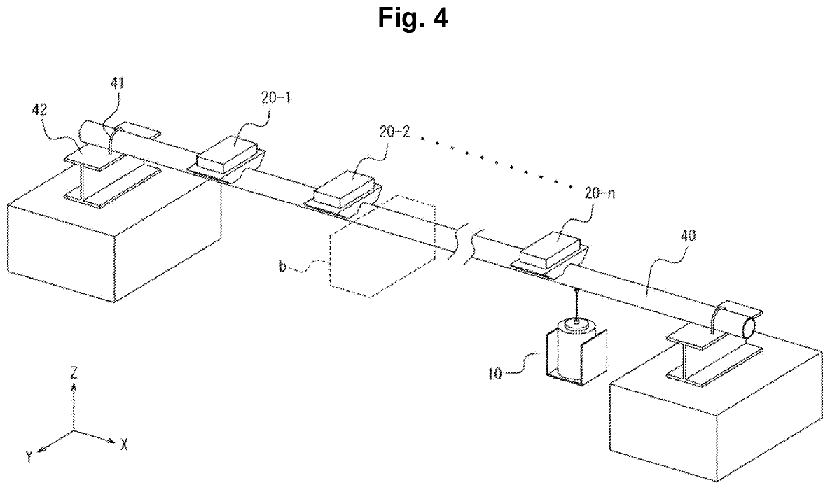

The tubular structure 40 is a pipe that supports social infrastructure provided at various places such as a bridge beam of a bridge by the U-bolt 41 and the supporting hardware 42. FIG. 2 is a schematic view of the tubular structure 40 in a good state. In FIG. 2 to FIG. 4, a horizontal direction (hereinafter, the direction is referred to as a Y-axis direction) and a vertical direction (hereinafter, the direction is referred to as a Z-axis direction) are defined. As illustrated in FIG. 2, the tubular structure 40 is fixed by the U-bolt 41 and the supporting hardware 42. Here, the supporting hardware 42 includes a supporting base of the supporting hardware 42. One or more triaxial accelerometers 20 are installed on the tubular structure 40. The tubular structure 40 is vibrated by the vibrator 10. In FIG. 2 to FIG. 4, as an example, the vibrator 10 vibrates the tubular structure 40 in the Z-axis direction. As will be described later, the vibrator 10 vibrates the tubular structure 40 in the Y-axis direction and further vibrates the tubular structure 40 in the Z-axis direction. FIG. 3 is a schematic view of the tubular structure 40 in a state where the U-bolt 41 is in a detached state. As illustrated in FIG. 3, the U-bolt 41 is in a detached state by being fallen off due to loosening at a position a that is surrounded by a broken line in the center. One supporting hardware 42 is in a good state. FIG. 4 is a schematic view of the tubular structure 40 in a state where the U-bolt 41 and the supporting hardware 42 are in a detached state. As illustrated in FIG. 4, the U-bolt 41 and the supporting hardware 42 are in a detached state by being fallen off from the tubular structure 40 at a position b that is surrounded by a broken line in the center.

The vibrator 10 vibrates the tubular structure 40 in each axis direction of a first axis direction and a second axis direction orthogonal to the first axis. The first axis direction is a horizontal direction (Y-axis direction). The second axis direction is a vertical direction (Z-axis direction). As illustrated in FIG. 2 to FIG. 4, a Y axis and a Z axis are orthogonal to each other. In the examples of FIG. 2 to FIG. 4, the vibrator 10 vibrates the tubular structure 40 in the Z-axis direction. Note that the vibrator 10 is unnecessary in a case where the tubular structure 40 vibrates due to environmental vibration.

One or more triaxial accelerometers 20 are installed on the tubular structure 40. As illustrated in FIG. 1, one or more triaxial accelerometers 20 include n triaxial accelerometers 20-1 to 20-n. The triaxial accelerometer 20-1 includes a measurement unit 21-1 that measures acceleration of the tubular structure 40 and a transmission unit 22-1 that transmits a measurement value to a reception unit 31 of the computation device 30. The triaxial accelerometers 20-2 to 20-n have the same configuration and function. The measurement units 21-1 to 21-n of the one or more triaxial accelerometers 20 measure acceleration of the tubular structure 40 each time the tubular structure 40 is vibrated in each axis direction of the first axis direction (Y-axis direction) and the second axis direction (Z-axis direction) orthogonal to the first axis. The transmission units 22-1 to 22-n transmit measurement values of the acceleration to the reception unit 31 of the computation device 30 in a wired manner or wireless manner such as Wi-Fi.

The computation device 30 derives a vibration mode in each axis direction of the first axis direction (Y-axis direction) and the second axis direction (Z-axis direction) based on the measurement values of the acceleration that are measured by the one or more triaxial accelerometers 20, and determines whether the U-bolt 41 is detached or the supporting hardware 42 is detached based on the vibration mode. Details of the computation device 30 will be described below.

### Computation Device

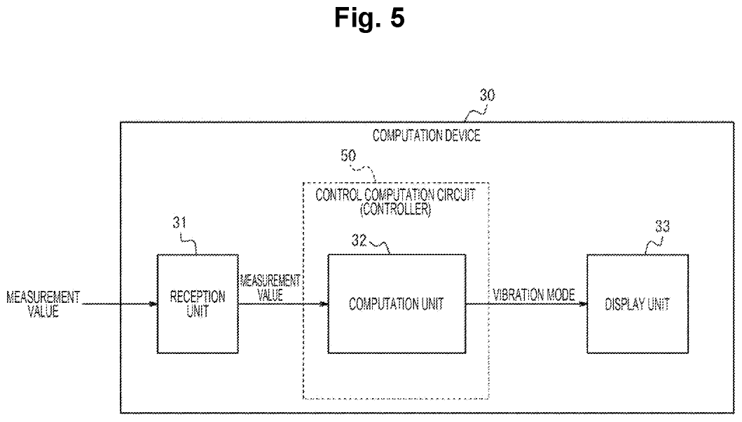

FIG. 5 is a block diagram illustrating a configuration example of the computation device according to the embodiment of the present disclosure. As illustrated in FIG. 5, the computation device 30 includes a reception unit 31, a computation unit 32, and a display unit 33. The computation device 30 determines detachment of the U-bolt 41 and the supporting hardware 42 that fix the tubular structure. The computation unit 32 is included in a control computation circuit (controller) 50. The control computation circuit 50 may be configured by dedicated hardware such as an application specific integrated circuit (ASIC) or a field-programmable gate array (FPGA), may be configured by a processor, or may be configured to include both dedicated hardware and a processor.

The reception unit 31 receives the measurement values of the acceleration of the tubular structure 40 from the transmission units 22-1 to 22-n of the one or more triaxial accelerometers 20 each time the tubular structure 40 is vibrated in each axis direction of the first axis direction (Y direction) and the second axis direction (Z direction) orthogonal to the first axis.

The computation unit 32 derives the vibration mode based on the measurement values of the acceleration, and determines whether the U-bolt 41 is detached or the supporting hardware 42 is detached based on the vibration mode.

Through experiments, the present inventors have confirmed that there is a relationship between detachment of each of the U-bolt 41 and the supporting hardware 42 that fix the tubular structure 40 and the vibration direction when the detachment is detected, as described in (i) to (iii) below. FIG. 2 to FIG. 4 are referred to again.

(i) In a case where the tubular structure 40 is vibrated in each axis direction of the first axis direction (Y direction) and the second axis direction (Z direction) orthogonal to the first axis, when the tubular structure 40 is immovable at the installation position of the U-bolt 41, the U-bolt 41 and the supporting hardware 42 are in a good state. (refer to FIG. 2)

(ii) In a case where the tubular structure 40 is vibrated in the first axis direction (Y direction), when a specific vibration mode is detected at the installation position of the U-bolt 41, the U-bolt 41 is in a detached state by being fallen off. (refer to FIG. 3)

(iii) In a case where the tubular structure 40 is vibrated in the second axis direction (Z direction) orthogonal to the first axis, when a specific vibration mode is detected at the installation position of the U-bolt 41, the supporting hardware 42 is in a detached state by being fallen off. (refer to FIG. 4)

### Vibration Mode by ODS Analysis

The computation unit 32 may derive the vibration mode by operating deflection shapes (ODS) analysis based on the measurement values of the one or more triaxial accelerometers 20.

The computation unit 32 computes an amplitude and a phase of the vibration by performing fast Fourier transform (FFT) on the received measurement values, and performs ODS analysis on the computation result. Thereby, the vibration mode of the tubular structure 40 is visualized and expressed. The ODS analysis is a simulation technique for analyzing a vibration pattern of a structure under an operation condition and visualizing the vibration pattern by animation or the like. The ODS analysis is also referred to as actual operation analysis.

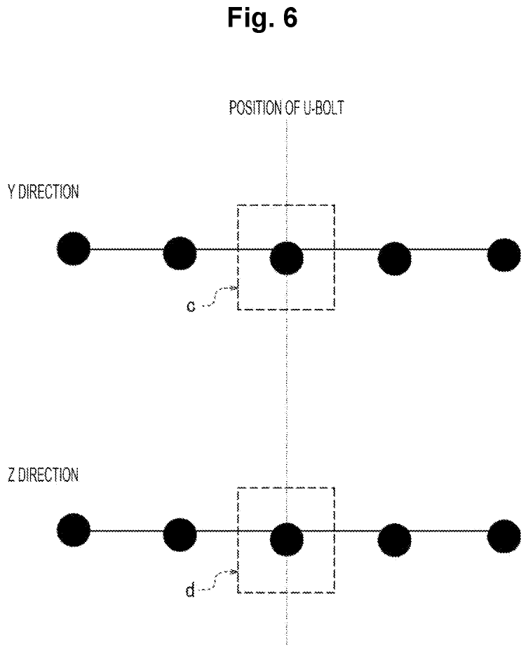

FIG. 6 is a diagram illustrating a vibration mode of the tubular structure by ODS analysis in a state where the U-bolt 41 and the supporting hardware 42 are in a good state (corresponding to FIG. 2). As illustrated in FIG. 6, the computation unit 32 determines that the U-bolt 41 is in a good state in a case where the vibration mode in the first axis direction (Y-axis direction) does not change at the installation position (a position c surrounded by a broken line in the center) of the U-bolt 41, and determines that the supporting hardware 42 is in a good state in a case where the vibration mode in the second axis direction (Z-axis direction) does not change at the installation position (a position d surrounded by a broken line in the center) of the U-bolt 41.

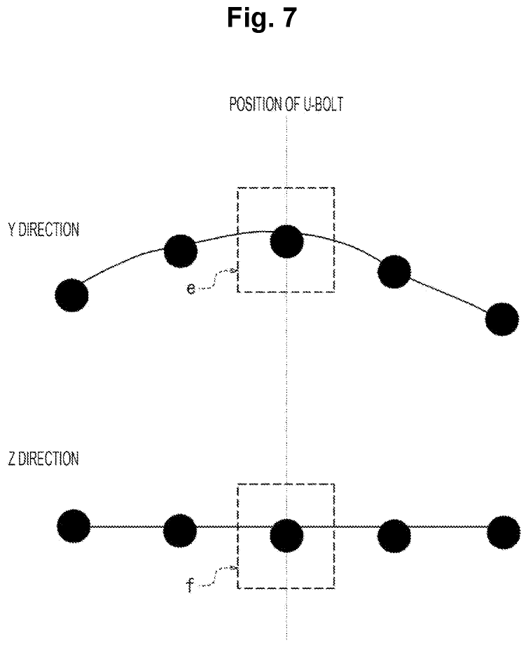

Next, as illustrated in FIG. 7, in a case where the vibration mode in the first axis direction (Y-axis direction) is displayed as a convex curve which has an amplitude equal to or larger than a first threshold value and has a maximum value at the installation position (a position e surrounded by a broken line in the center) of the U-bolt 41, the computation unit 32 determines that the U-bolt 41 is detached. The vibration mode in the second axis direction (Z-axis direction) does not change at the installation position of the U-bolt 41 (a position f surrounded by a broken line in the center), and thus the computation unit 32 determines that the supporting hardware 42 is in a good state.

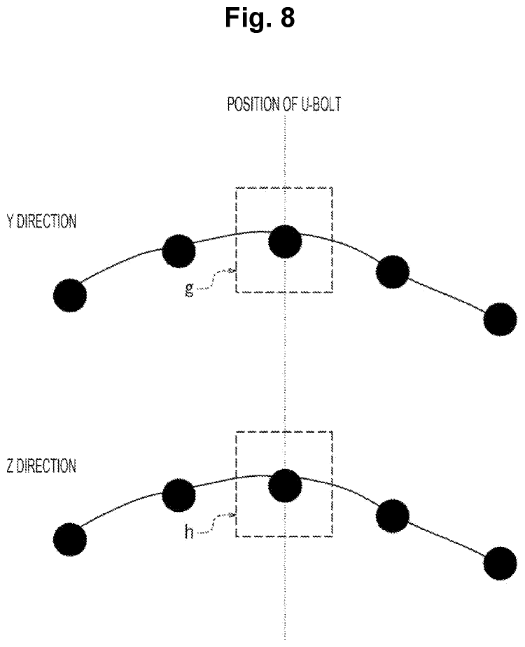

In addition, as illustrated in FIG. 8, the vibration mode in the first axis direction (Y-axis direction) is displayed as a convex curve which has an amplitude equal to or larger than a first threshold value and has a maximum value at the installation position (a position g surrounded by a broken line in the center) of the U-bolt 41, and thus the computation unit 32 determines that the U-bolt 41 is also detached. Further, in a case where the vibration mode in the second axis direction (Z-axis direction) is displayed as a convex curve which has an amplitude equal to or larger than a second threshold value and has a maximum value at the installation position (a position h surrounded by a broken line in the center) of the U-bolt 41, the computation unit 32 determines that the supporting hardware 42 is detached.

### Vibration Mode by Frequency Response Function

The computation unit 32 may derive the vibration mode from a frequency response function based on the measurement values of the one or more triaxial accelerometers 20.

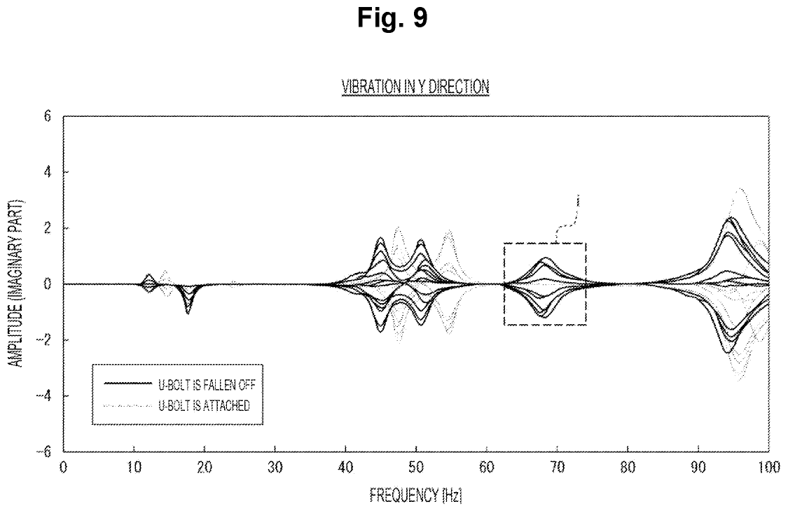

FIG. 9 is a graph of a frequency response function representing a specific vibration mode i for detecting that the U-bolt 41 is in a detached state. In a case where a frequency response function derived based on the measurement values of the acceleration of the tubular structure 40 which is vibrated in the first axis direction (Y-axis direction) represents a vibration mode (a vibration mode i surrounded by a broken line in the center) that has an amplitude equal to or larger than a third threshold value in a specific frequency band, the computation unit 32 determines that the U-bolt 41 is detached. In FIG. 9, the specific frequency band is a frequency band around 70 Hz.

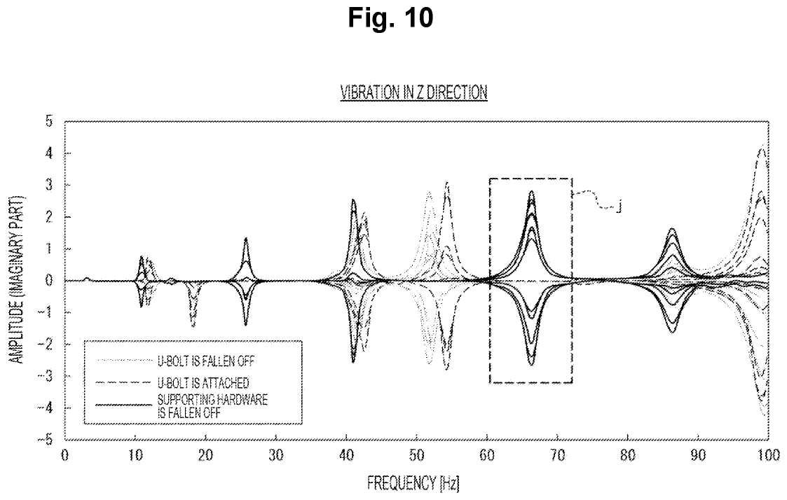

FIG. 10 is a graph of a frequency response function representing a specific vibration mode j for detecting that the supporting hardware is in a detached state. In a case where a frequency response function derived based on the measurement values of the acceleration of the tubular structure 40 which is vibrated in the second axis direction (Z-axis direction) represents a vibration mode (a vibration mode j surrounded by a broken line in the center) that has an amplitude larger than the third threshold value and equal to or larger than a fourth threshold value in a specific frequency band, the computation unit 32 determines that the supporting hardware 42 is detached. In FIG. 10, the specific frequency band in which the vibration mode j appears is a frequency band around 70 Hz that is the same as the frequency band in the vibration mode i. As illustrated in FIG. 10, the vibration mode j has a larger amplitude than the amplitude of the vibration mode i.

From FIG. 9 and FIG. 10, in a case where the specific vibration mode j representing detachment of the supporting hardware does not appear even when the tubular structure 40 is vibrated in the Z-axis direction and the vibration mode i appears when the tubular structure 40 is vibrated in the Y-axis direction, it is determined that the U-bolt 41 is detached due to loosening. On the other hand, in a case where the tubular structure 40 is vibrated in the Z-axis direction and the specific vibration mode j representing detachment of the supporting hardware appears, it is determined that the supporting hardware 42 is detached by being fallen off.

The display unit 33 displays and visualizes the vibration modes in each axis direction of the Y-axis direction and the Z-axis direction based on the ODS analysis and the frequency response function. The display unit 33 is a display.

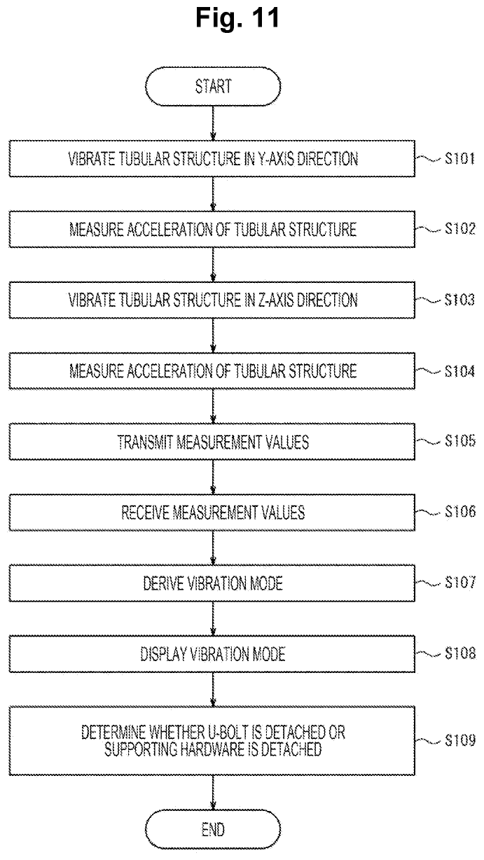

FIG. 11 is a flowchart illustrating an example of a monitoring method executed by the monitoring system according to the embodiment of the present disclosure.

In step S101, the vibrator 10 vibrates the tubular structure 40 in the Y-axis direction.

In step S102, the measurement units 21-1 to 21-n of the one or more triaxial accelerometers 20 measure acceleration of the tubular structure 40.

In step S103, the vibrator 10 vibrates the tubular structure 40 in the Z-axis direction.

In step S104, the measurement units 21-1 to 21-n of the one or more triaxial accelerometers 20 measure acceleration of the tubular structure 40.

In step S105, the transmission units 22-1 to 22-n of the one or more triaxial accelerometers 20 transmit the measurement values of the acceleration that are measured in step S102 and step S104.

In step S106, the reception unit 31 of the computation device 30 receives the measurement values.

In step S107, the computation unit 32 of the computation device 30 derives a vibration mode in each axis direction of the Y-axis direction and the Z-axis direction.

In step S108, the display unit 33 of the computation device 30 displays the vibration mode in each axis direction of the Y-axis direction and the Z-axis direction.

In step S109, the computation unit 32 of the computation device 30 determines whether the U-bolt is detached or the supporting hardware is detached.

As described above, there is a relationship between a direction in which vibration is generated and a detached state of the U-bolt 41 and the supporting hardware 42. With the monitoring system 1 according to the present disclosure, by observing vibration for each vibration direction, it is possible to constantly and remotely determine detachment of the U-bolt 41 and the supporting hardware 42.

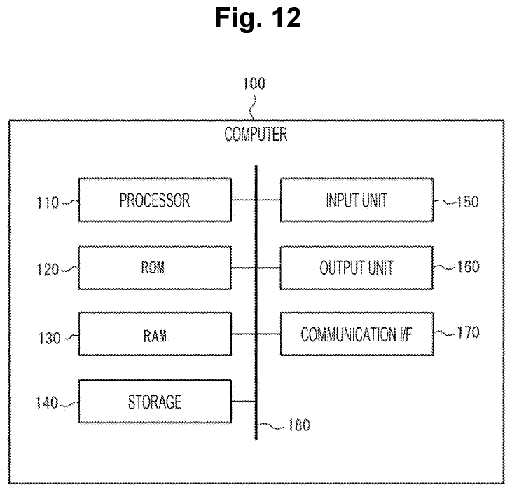

In order to cause the computation device 30 to function, it is also possible to use a computer capable of executing a program instruction. FIG. 12 is a block diagram illustrating a schematic configuration of a computer that functions as the computation device 30. Here, the computer that functions as the computation device 30 may be a general-purpose computer, a dedicated computer, a workstation, a personal computer (PC), an electronic note pad, or the like. The program instruction may be a program code, a code segment, or the like, for executing a necessary task.

As illustrated in FIG. 12, the computer 100 includes a processor 110, a read only memory (ROM) 120, a random access memory (RAM) 130, a storage 140 as storage units, an input unit 150, an output unit 160, and a communication interface (I/F) 170. The components are communicably connected to each other via a bus 180.

The ROM 120 stores various kinds of programs and various kinds of data. The RAM 130 temporarily stores a program or data as a working area. The storage 140 includes a hard disk drive (HDD) or a solid state drive (SSD) and stores various programs including an operating system and various kinds of data. In the present disclosure, a program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like, and may be configured by the same or different types of plurality of processors. The processor 110 reads a program from the ROM 120 or the storage 140 and executes the program by using the RAM 130 as a working area to perform control of the components and various kinds of computation processing. Note that at least a part of these processing contents may be realized by hardware.

The program may be recorded in a recording medium that can be read by the computation device 30. In a case where such a recording medium is used, the program can be installed in the computation device 30. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. In addition, the program may be downloaded from an external device via a network.

With regard to the embodiment described above, the following appendixes are further disclosed.

### Appendix 1

A monitoring system that remotely monitors detachment of a U-bolt and supporting hardware for fixing a tubular structure, the monitoring system including:
a vibrator that vibrates the tubular structure in each axis direction of a first axis direction and a second axis direction orthogonal to the first axis; one or more triaxial accelerometers that are provided on the tubular structure and measure acceleration each time the tubular structure is vibrated in each axis direction of the first axis direction and the second axis direction; and a computation device that derives a vibration mode in each axis direction of the first axis direction and the second axis direction based on measurement values of the acceleration and determines whether the U-bolt is detached or the supporting hardware is detached based on the vibration mode.

### Appendix 2

A computation device that determines detachment of a U-bolt and supporting hardware for fixing a tubular structure, the computation device including:
a receiver that receives measurement values of acceleration from one or more triaxial accelerometers each time the tubular structure is vibrated in each axis direction of a first axis direction and a second axis direction orthogonal to the first axis; a controller that derives a vibration mode based on the measurement values and determines whether the U-bolt is detached or the supporting hardware is detached based on the vibration mode; and a display that displays and visualizes the vibration mode.

### Appendix 3

The computation device according to the appendix 2, in which
the controller determines that the U-bolt is detached in a case where the vibration mode in the first axis direction is displayed as a convex curve which has an amplitude equal to or larger than a first threshold value and has a maximum value at an installation position of the U-bolt, and
determines that the supporting hardware is detached in a case where the vibration mode in the second axis direction is displayed as a convex curve which has an amplitude equal to or larger than a second threshold value and has a maximum value at an installation position of the U-bolt.

### Appendix 4

The computation device according to the appendix 2, in which the controller determines that the U-bolt is detached in a case where a frequency response function derived based on the measurement values of the acceleration of the tubular structure which is vibrated in the first axis direction represents a vibration mode having an amplitude equal to or larger than a third threshold value in a specific frequency band, and determines that the supporting hardware is detached in a case where a frequency response function derived based on the measurement values of the acceleration of the tubular structure which is vibrated in the second axis direction represents a vibration mode having an amplitude equal to or larger than a fourth threshold value larger than the third threshold value in the specific frequency band.

### Appendix 5

A monitoring method that remotely monitors detachment of a U-bolt and supporting hardware for fixing a tubular structure, the monitoring method comprising: vibrating, via a vibrator, the tubular structure in each axis direction of a first axis direction and a second axis direction orthogonal to the first axis; measuring, via one or more triaxial accelerometers, acceleration each time the tubular structure is vibrated in each axis direction of the first axis direction and the second axis direction;
deriving, via a computation device, a vibration mode in each axis direction of the first axis direction and the second axis direction based on measurement values; and determining, via the computation device, whether the U-bolt is detached or the supporting hardware is detached based on the vibration mode.

Although the above-described embodiment has been described as the representative example, it is apparent to those skilled in the art that various modifications and substitutions can be made within the spirit and scope of the present disclosure. Therefore, it should be understood that the present invention is not limited by the above-described embodiment, and various modifications or changes can be made without departing from the scope of the claims. For example, a plurality of configuration blocks described in the configuration diagram of the embodiment can be combined into one, or one configuration block can be divided.

### REFERENCE SIGNS LIST

1 Monitoring system
10 Vibrator
20 One or more triaxial accelerometers
20-1 to 20-n Triaxial accelerometer
21-1 to 21-n Measurement unit
22-1 to 22-n Transmission unit
30 Computation device
31 Reception unit (receiver)
32 Computation unit
33 Display unit (display)
40 Tubular structure (monitoring target object)
41 U-bolt
42 Supporting hardware
50 Control computation circuit (controller)
100 Computer
110 Processor
120 ROM
130 RAM
140 Storage
150 Input unit
160 Output unit
170 Communication interface (I/F)
180 Bus

1. A monitoring system comprising a processor configured to execute operations comprising:
applying vibration on a tubular structure in each axis direction of a first axis direction of a first axis and a second axis direction of a second axis, wherein the second axis direction is orthogonal to the first axis;
receiving a measured value of acceleration of the tubular structure when the tubular structure vibrates as caused by the applying vibration in said each axis direction of the first axis direction and the second axis direction;
determining a vibration mode in said each axis direction of the first axis direction and the second axis direction based on the measured value of acceleration; and
determining, based on the vibration mode, whether a U-bolt is detached or a supporting hardware is detached based on the vibration mode, as a result of remotely monitoring detachment of the U-bolt and the supporting hardware for maintaining the tubular structure in place.

2. A computation device comprises a processor configured to execute operations comprising:
receiving a measurement value of acceleration when a tubular structure is vibrated in each axis direction of a first axis direction of a first axis and a second axis direction of a second axis, wherein the second axis is orthogonal to the first axis; determining a vibration mode based on the measurement value;
determining whether a U-bolt is detached or a supporting hardware is detached based on the vibration mode; and
displaying and visualizes the vibration mode.

3. The computation device according to claim 2, the processor further configured to execute operations comprising:
determining that the U-bolt is detached in a case where the vibration mode in the first axis direction is displayed as a convex curve which has an amplitude equal to or larger than a first threshold value and has a maximum value at an installation position of the U-bolt.

4. The computation device according to claim 2, the processor further configured to execute operations comprising:
determining that the U-bolt is detached in a case where a frequency response function derived based on the measurement value of the acceleration of the tubular structure which is vibrated in the first axis direction represents a vibration mode having an amplitude equal to or larger than a third threshold value in a specific frequency band.

5. A monitoring method for remotely monitoring detachment of a U-bolt and supporting hardware for fixing a tubular structure, the monitoring method comprising:
a step of applying vibration on the tubular structure in each axis direction of a first axis direction of a first axis and a second axis direction of a second axis, wherein the second axis is orthogonal to the first axis;
a step of receiving measured acceleration of the tubular structure when the tubular structure vibrates as caused by the applying vibration in said each axis direction of the first axis direction and the second axis direction;
a step of determining, a vibration mode in said each axis direction of the first axis direction and the second axis direction based on the measured acceleration; and
a step of determining whether the U-bolt is detached or the supporting hardware is detached based on the vibration mode.

6. The monitoring system according to claim 1, wherein the U-bolt attaches to the tubular structure, the supporting hardware attaches to the U-bolt and a bridge beam of a bridge.

7. The monitoring system according to claim 1 further comprises:
a triaxial accelerator, wherein the triaxial accelerator attaches to the tubular structure and measures a value of acceleration of movement of the tubular structure caused by the applied vibration.

8. The monitoring system according to claim 1, wherein the vibration mode represents a vibration pattern of the tubular structure.

9. The monitoring system according to claim 1, wherein the vibration mode is based on operation deflection shapes (ODS) analysis.

10. The monitoring system according to claim 1, wherein the vibration mode is based on a frequency response function.

11. The computation device according to claim 2, the processor further configured to execute operations comprising:
determining that the supporting hardware is detached in a case where the vibration mode in the second axis direction is displayed as a convex curve which has an amplitude equal to or larger than a second threshold value and has a maximum value at an installation position of the U-bolt.

12. The computation device according to claim 2, the processor further configured to execute operations comprising:
determining that the supporting hardware is detached in a case where a frequency response function derived based on the measurement value of the acceleration of the tubular structure which is vibrated in the second axis direction represents a vibration mode having an amplitude equal to or larger than a fourth threshold value larger than a third threshold value in a specific frequency band.
